(19) United States
(12) Patent Application Publication
(10) Pub. No.: US 2025/0322341 A1
(43) Pub. Date: Oct. 16, 2025

(54) APPARATUS AND METHOD FOR GENERATING RESOLUTION DATA

(71) Applicant: HS VK IDEA FACTORY, LLC, Westminister, CO (US)

(72) Inventors: Veljko Krunic, Westminster, CO (US); Helen Stella, Westminster, CO (US)

(73) Assignee: HS VK IDEA FACTORY, LLC, Westminister, CO (US)

(21) Appl. No.: 19/174,621

(22) Filed: Apr. 9, 2025

Related U.S. Application Data
(60) Provisional application No. 63/632,027, filed on Apr. 10, 2024.

(51) Int. Cl. G06Q 10/0637

(52) U.S. Cl. CPC G06Q 10/0637

(57) ABSTRACT

The disclosures are directed to processing systems and methods that apply artificial intelligence-based processes to match an input to one of multiple options. In one example, a processor receives input data and, based on inputting the input data to a large language model (LLM), generates graph data that associates each of multiple propositions to one or more entities. Further, based on inputting the graph data to a trained artificial intelligence (AI) model, the processor generates query data characterizing one or more queries. In addition, based on inputting the graph data and the query data to the same or different LLM, the processor generates matching data charactering associations between the multiple propositions and the one or more queries. The processor may then receive a query request, and can match the query request to at least one of the multiple propositions based on the matching data.

### CROSS-REFERENCES TO RELATED APPLICATIONS

The application claims priority to U.S. Provisional Patent Application No. 63/632,027, filed Apr. 10, 2024, and entitled “METHOD AND APPARATUS FOR GRAPH-BASED DESCRIPTION OF MARKET PARTICIPANT GOALS AND ESTIMATION OF MARKET,” the contents of which are incorporated herein in their entirety.

### FIELD OF THE INVENTION

The disclosure relates generally to data processing systems that employ artificial intelligence-based processes.

### BACKGROUND

Artificial intelligence is used across a wide variety of applications. For example, computing systems employ artificial intelligence models for various business reasons, such as for making marketing and advertising decisions, and for making consumer purchasing predictions. These computing systems suffer from various drawbacks. For example, the artificial intelligence models do not produce results as quickly as users prefer, and do not make certain types of decisions that can assist businesses. As such, there are opportunities to address deficiencies of artificial intelligence-based systems and processes.

### SUMMARY

In some embodiments, an apparatus includes a memory storing instructions, and a processor communicatively coupled to the memory. The processor is configured to execute the instructions to receive graph structure data characterizing associations between a plurality of entities and a plurality of propositions. The processor is also configured to execute the instructions to receive goal data characterizing a plurality of goals. Further, the processor is configured to execute the instructions to input the graph structure data and the goal data to an analytics model and, in response, generate graph data characterizing associations between the plurality of propositions and the plurality of goals. The processor is also configured to execute the instructions to input market data for the plurality of entities and the graph data to a large language model and, in response, generate resolution data characterizing at least one of the plurality of propositions. The processor is further configured to execute the instructions to store the resolution data in a data repository.

In some embodiments, a method by at least one processor includes receiving graph structure data characterizing associations between a plurality of entities and a plurality of propositions. The method also includes receiving goal data characterizing a plurality of goals. Further, the method includes inputting the graph structure data and the goal data to an analytics model and, in response, generating graph data characterizing associations between the plurality of propositions and the plurality of goals. The method also includes inputting market data for the plurality of entities and the graph data to a large language model and, in response, generating resolution data characterizing at least one of the plurality of propositions. The method further includes storing the resolution data in a data repository.

In some embodiments, a non-transitory, computer readable medium includes instructions stored thereon. The instructions, when executed by at least one processor, cause the at least one process to perform operations including receiving graph structure data characterizing associations between a plurality of entities and a plurality of propositions. The operations also include receiving goal data characterizing a plurality of goals. Further, the operations include inputting the graph structure data and the goal data to an analytics model and, in response, generating graph data characterizing associations between the plurality of propositions and the plurality of goals. The operations also include inputting market data for the plurality of entities and the graph data to a large language model and, in response, generating resolution data characterizing at least one of the plurality of propositions. The operations further include storing the resolution data in a data repository.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 illustrates a graph indicating connections between persons and goals, in accordance with some embodiments;

FIG. 2 illustrates a metamodel of a sales market structure, in accordance with some embodiments;

FIG. 3 illustrates an example market structure in accordance with the metamodel of FIG. 2, in accordance with some embodiments;

FIG. 4 illustrates a block diagram of a data processing pipeline to generate resolution data indicating a likelihood that a value proposition will be accepted, in accordance with some embodiments;

FIG. 5 illustrates a market graph indicating entity influences, in accordance with some embodiments;

FIG. 6 illustrates a block diagram of a method to analyze artificial intelligence-based decisions, in accordance with some embodiments;

FIG. 7 illustrates a dashboard that visualizes value propositions for a market segment, in accordance with some embodiments;

FIG. 8 illustrates a graph of factors related to goals of a group of unexpected buyers, in accordance with some embodiments;

FIG. 9 illustrates a market graph indicating entity influences, in accordance with some embodiments;

FIG. 10 illustrates a block diagram of a method to generate inference data in accordance with a typed graph, in accordance with some embodiments;

FIG. 11 is a block diagram of a computing device, in accordance with some embodiments;

FIG. 12 is a block diagram of sales guidance system, in accordance with some embodiments;

FIG. 13 illustrates a block diagram of a data processing pipeline to generate resolution data, in accordance with some embodiments; and

FIG. 14 illustrates a flowchart to generate resolution data, in accordance with some embodiments.

### DETAILED DESCRIPTION

The typical marketing and sales approach assumes that if there is a high-level match between a value proposition and the chosen market segments that could be articulated, the job of sales and marketing is to approach the customers in these market segments and close the sales. Traction is seen as a number of closed sales and revenue growth in a period, and the assumption is that the diffusion of sales through the total addressable market is, for all intents and purposes, mostly a random process. Viral growth is perceived as a result of brilliant products, sales execution, and even luck.

In real markets, especially in the business-to-business (B2B) context, different market players and their employees have different powers to shape decisions based on the power structure of the organizations participating in the market. Some people and organizations are more influential than others, and their adoption of a product makes it more likely that other market participants will do so. There could also be a regulatory aspect, in which full adaptation is possible only if regulations (or standard operating procedures) in the industry are made compatible with the product (e.g., this is a common situation in the medical device field).

For example, typical B2B marketing and sales efforts are based on identifying the market segment and then finding people in that market segment that the company can sell to. In a typical sales organization, marketing would try to develop material that the media and buyers are expected to find interesting; the sales development organization would make initial contact with a potential customer, and if the customer responds, they would typically be transferred to the sales organization that would work on closing the sale. On the level of the organization attempting the sale, there could be a lot of information collected about the customer, the processes used for initiating contact, explaining value propositions, and advancing the sale. Collecting and understanding that information requires heavy human involvement, with customization of the sales proposals made to a potential customer being frequent, manual, and limited by the information that a person making contact can easily access, comprehend, and analyze.

Collection, comprehension, and analysis invariably run into the limit of human perception and ability to comprehend complex interactions. Crucial information gets overlooked or is never made available to some participants. Methods used to combat that limitation of human cognition are typically based on the increasing number of participants and additional people involved in the review of the information and sales strategy. Often, the hope is that scheduling a review meeting(s) in preparation for the initial approach or the meeting with the customer would bring relevant information into the open. This approach faces inherent complexity in the cases of complex sales with many internal stakeholders.

One advantage of at least one embodiment described herein is the generation of resolution data that bridges the gap between the diffuse understanding of the total addressable market and the actual structure of the market, as well as shaping customer value propositions to that of the actual structure of the market, and the ability to predict the ability of a product to capture the market.

For instance, in some examples, a processing system receives input data (e.g., entity data, market data, graph structure data) and, based on the input data, generates graph data that associates each of multiple propositions (e.g., business solutions) to one or more entities (e.g., persons, businesses). For example, the processing system may input the input data to an executed large language model (LLM) and, based on inputting the input data to the LLM, the processing system may generate the graph data. Further, based on the graph data, the processing system generates query data characterizing one or more queries. For example, the processing system may input the graph data to a trained artificial intelligence (AI) model and, based on the inputting the graph data to the trained AI model, the processing system may generate the query data.

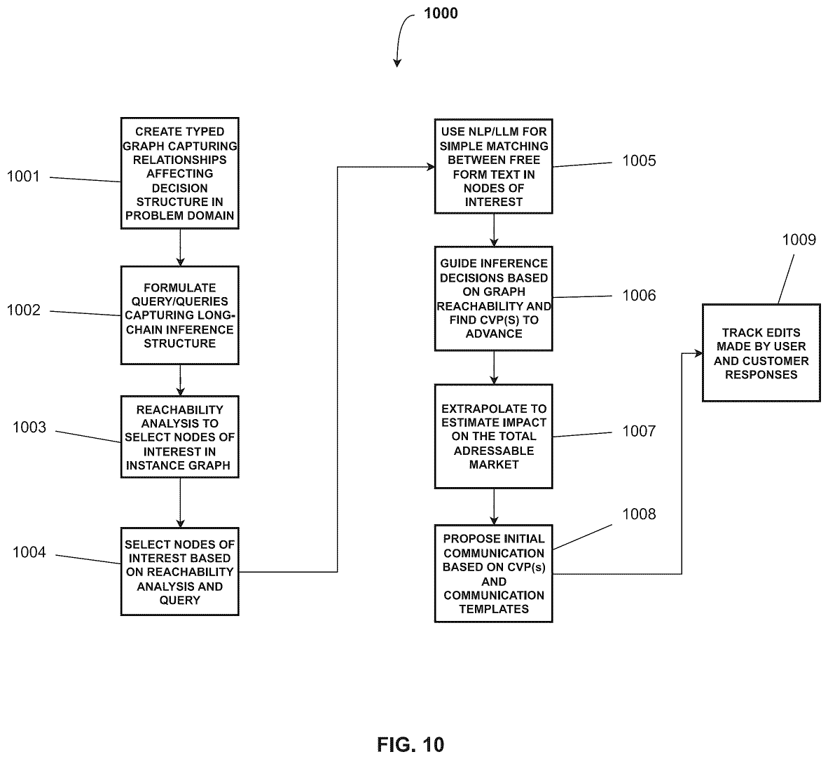

In addition, based on the graph data and the query data, the processing system generates matching data charactering associations between the multiple propositions and the one or more queries. For example, the processing system may input the graph data and the query data to the same or different LLM and, in response, generates the matching data. The processing system can store the matching data in a memory device, such as a cloud-based memory storage, or local storage device. Further, the processing system receives a query request. In response, the processing system performs operations to match the query request to at least one of the queries characterized by the matching data, execute a sequence of the graph operation using graph structure to guide a decision process (e.g., steps 1003 and 1004 on FIG. 10), and generate resolution data identifying at least one of the propositions associated with the matched query. For example, the processing system may input the query request and the matching data to the LLM and, in response, generate the resolution data. For example, the LLM can determine which one of the queries characterized by the matching data best matches the received query request and, once determined, can generate the resolution data identifying any proposition that is associated to the matched query characterized by the matching data.

In some examples, a processing system inputs information from various sources to an LLM and, in response, receives from the LLM graph data characterizing a graph of the market (e.g., as it is today). Further, based on a receiving data characterizing a given marketing strategy, the processing system generates queries necessary for long term inference structure. The processing system then generates node data identifying nodes of the graph of the market that match each of the generated queries. The processing system can also receive a query request, and can match the query request to one of the generated queries. Based on the matched query, the processing system generates resolution data characterizing at least one Customer Value Propositions.

In some examples, a processing system receives graph data characterizing associations between a plurality of propositions and a plurality of goals. The processing system determines that at least a first of the plurality of propositions is associated with at least a first of the plurality of goals, and not associated with at least a second of the plurality of goals. Further, the processing system receives graph structure data characterizing associations between a plurality of entities and the plurality of propositions. The processing system inputs the first of the plurality of propositions and the graph structure data to an analytics model and, in response, generates resolution data characterizing whether the first of the plurality of propositions should be proposed. For example, if the first of the plurality of propositions is associated with a first of the plurality of entities that is higher on an organization chart than a second of the plurality of entities that is not associated with the first of the plurality of entities, the resolution data is generated to indicate that the first of the plurality of propositions should be proposed. The processing system stores the resolution data in a data repository.

In some examples, a processing system receives graph data characterizing associations between a plurality of propositions and a plurality of goals. The processing system generates a ranking score for each of the associations based on applying a path finding algorithm (e.g., Dijkstra's algorithm) to the graph data. Further, and based on the ranking scores, the processing system determines a subset of the plurality of propositions. The processing system provides the subset of the plurality of propositions for display.

In some examples, a processing system automatically selects Customer Value Propositions (CVPs) that match the goal(s) of the plurality of the people or institutions, taking possible conflicting goals into account, where conflicts could be conflicts between interests of meeting participants or conflicts of the various organizational members (e.g., the goal of the subordinate could conflict with the goal of the of their superior). Further, and in some examples, an embodiment allows for estimating the market size that the product would appeal to based on its current CVP(s). In yet another example, a processing system can elicit CVP(s) that best match goals that market participants share (e.g., with some of the elicited CVP(s) being new CVP(s)). In yet another example, a processing system aggregates data to track market traction that CVPs are receiving.

In some examples, the processing system analyzes user manual edits to determine if there are common latent factors among edits that resulted in the successful approach with the customer. In some examples, the processing system combines CVP(s) among a plurality of entities to create a joint proposal in which a plurality of business entities could make a joint proposition (e.g., that a subset of those entities can't make). In some examples, the processing system predicts the chance of success in the market based on the portion of the existing graph that has viable CVP(s), and compares the size of the graph that could potentially be covered with existing CVP(s). In some examples, the processing system extrapolates the prediction to a total addressable market based on the current CVP(s). In some examples, the processing system performs a commonality analysis across a plurality of unmet customer goals to determine at least one common latent factors.

In some examples, a processing system receives graph structure of the goal(s) and power structure of the group of participant(s), and determines a match between one or more CVP(s) with one or more goal(s) of participants. The processing system also determines CVP(s) that matches goal(s) of all participants, if there are no conflicting goals. Further, the processing system determines CVP(s), based on power relationships, that address the subset of conflicting goals that are important to more powerful participants, if there are conflicting goals. The processing system reports (e.g., transmits, displays) the match of CVP(s) with goal(s), and reports on which goal(s) of the participants were addressed and to what extent.

In some examples, the processing system selects CVP(s) to be made to address goals(s) of participant(s) by combining the graph structure of the goal(s) and power structure of the participant(s), with scoring the match between description of the goal(s) and CVP(s). In some examples, the processing system resolves conflicting goal(s) by using power structures of the group to select CVP(s) that meet the goal(s) of influential participants, to the extent that goal(s) of influential participants can be met at the same time. In some examples, the processing system uses the typed graph describing domain-specific relationships and graph algorithm to augment the inference limitations of the AI technology such as LLM and NLP processing techniques. The graph is used to guide the long-chain inference decisions and NLP/LLM techniques are used for the unstructured data resolution/short-chain inference.

In some examples, the processing system uses sensitivity analysis of the decision to rank decision(s) made by AI system in their order of influence on the final decision for proposing CVP(s). In some examples, the processing system allows the user to mark “low confidence” nodes/relationships in the graph and performing sensitivity analysis of the decision accounting for low confidence nodes in the impact on the final decision. In some examples, the processing system verifies the decisions of AI systems that are subject to errors and hallucinations by guiding human review based on the order of importance of individual AI decisions for the final decision of the AI. In some examples, the processing system performs recalculation of goal(s) and CVP(s) matches. Recalculation could be manually requested by the user or triggered automatically based on predefined criteria (e.g., a new info entering system). When the processing system determines this information would materially affect active negotiations/sales, an alert to a user may be issued (e.g., transmitted, displayed).

In some examples, the processing system selects the next person to approach based on the power structure and the quality of the CVP(s) match, without needing to expose the full structure of the graph to every user of the system. In some examples, the processing system uses the templating and modifying template with matching CVP(s) to propose an approach script for the next person to approach. In some examples, the processing system allows for the ability for users to manually edit the content of the approach script and tracking success of the approach script in approaching the customer. In some examples, the processing system analyzes user manual edits to determine if there are common latent factors among edits that resulted in the successful approach with the customer.

In some examples, the processing system combines CVP(s) among the plurality of entities in order to create a joint proposal(s) in which a plurality of the business entities could make a joint proposition that a subset of those entities can't make. In some examples, the processing system receives different input modalities or combination of input modalities (e.g. text, video, audio, and any other sensory information) as a source of information.

In some examples, the processing system predicts the chance of success in the market based on the portion of the existing graph that has viable CVP(s) and comparing the size of the graph that could potentially be covered with existing CVP(s). In some examples, the processing system extrapolates the prediction made to a prediction of total addressable market you are able to capture based on the current CVP(s). In some examples, the processing system performs a commonality analysis across a plurality of unmet customer goal(s) to find common latent factors among those unmet goal(s).

In some examples, the processing system tracks metric(s) and their use for the management support system tracking the success of the current sales strategy and broader company strategy. In some examples, the processing system applies the above processes to any group of entities that could be described with the graph structure equivalent to the graph of market relationships.

Among other advantages, the embodiments can efficiently and accurately apply artificial intelligence-based processes to generate resolution data characterizing a suggested resolution based on input data (e.g., such as goal data). For instance, the embodiments can, in at least certain circumstances, allow for the automated selection of propositions (e.g., CVPs) that match the goals of entities, such as people or institutions, even when there are conflicting goals. In addition, the embodiments can then match an input inquiry to at least one of the CVPs. As a result, the embodiments can efficiently and accurately direct an entity to a preferred course of action, thereby reducing time and effort to reach suboptimal courses of action and/or the preferred course of action. Persons of ordinary skill in the art having the benefit of these disclosures may recognize these and other advantages of the various embodiments as well.

Moreover, although at least some of the embodiments are described herein with respect to sales and/or marketing activities, the embodiments can be applied in other areas as well. For instance, at least some embodiments can be applied to investment banking, investment management, trial law, estate law, and any other suitable areas. Indeed, the embodiments can be applied to various situations that involve communications between humans.

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

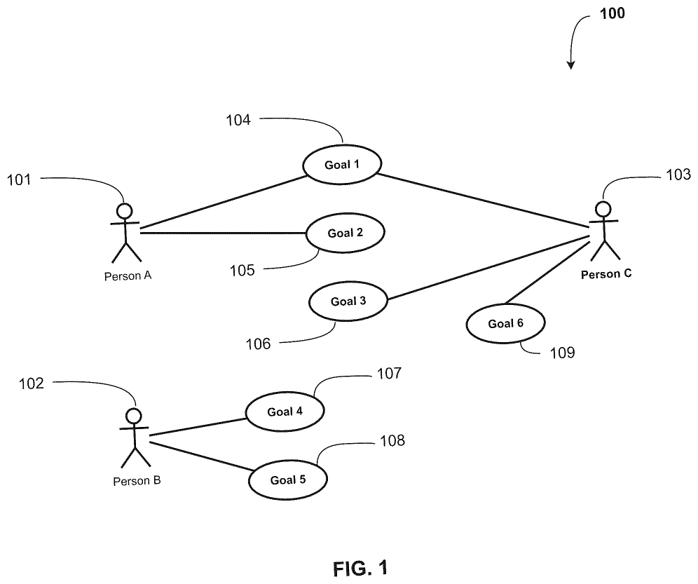

Turning to drawings, FIG. 1. illustrates a graph 100 of a sales-related meeting with three stakeholders include Person A 101, Person B 103, and Person C 103, along with a plurality of goals that each of the participants has. For example, Person A (101) has Goal 1 (104) and Goal 2 (105). Person B (102) has goal 4 (107) and goal 5 (108), and Person C (103) has Goal 3 (106), Goal 6 (109), and further shares Goal 1 (104) with Person A (101). The goals 104, 105, 106, 107, 108, and 109 could be complementary, independent, or even mutually exclusive of each other.

The ability to make attractive proposals is based on finding CVP(s) that customers would perceive as likely to address their goals. Of course, there is no universal CVP(s) that could address every possible goal that any customer has-a process of finding CVP(s) and relating them to goals is what marketing and selling is about.

It is typical when having a meeting with a plurality of people that they have multiple goals (e.g., ones shown in FIG. 1). It is also typical that meeting participants have a diversity of goals, as well as unequal and complex influences on making decisions. It is also possible that CVPs that are a good match for some goals are a poor match for other goals, or that all goals can't be satisfied at the same time because they inherently conflict with each other, forcing sales personal to choose which goals are more important to address to close a sale. Typically, a stakeholder that controls a budget has more influence than a stakeholder without a budget or any direct way to block a sale, such as a person who is only notified about the decision post facto and can only try to object to a decision retrospectively. However, if the latter stakeholder is highly esteemed by the stakeholder with a budget, the notification-only stakeholder can also be very important.

It is doubtful that the average sales team could correctly account for all the factors influencing buying decisions in every interaction with the stakeholders. The number of factors you need to keep in mind is significant and challenging to think about in real-time, and the information you have is usually presented in textual form (e.g., call notes) which are not easy to review quickly.

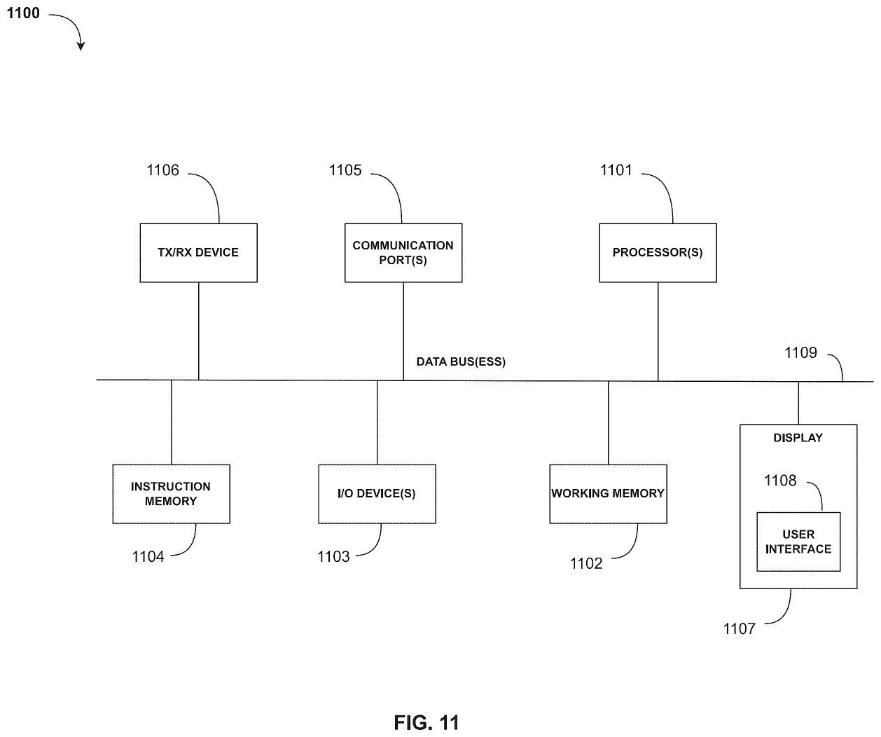

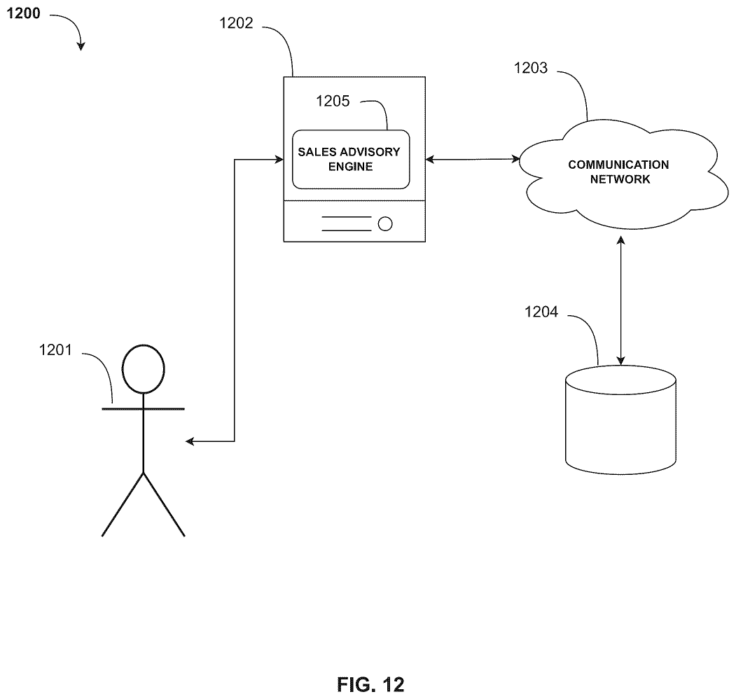

To guide the user to the complexity of the sales, FIG. 12 illustrates user guidance system 1200 that uses sales advisory engine 1205 to generate data that can advise the user 1201 about a matching between the goals of the sales targets (such as Person A 101, Person B 102, and Person C 103) with actions a user could take to match their goals. Sales advisory engine 1205 runs on the computer system 1202 and is communicationally coupled over network 1203 with the data repository 1204 (e.g., persistent storage). The computing device 1202 could be an instance of the broader class of computing devices 1100 described in FIG. 11.

FIG. 11 illustrates an example of a control device, 1100. In some examples, the system includes control device 1100. In this example, control device 1100 includes one or more processors 1101, working memory 1102, one or more input/output devices 1103, instruction memory 1104, a transceiver 1106, one or more communication ports 1105, and a display 1107, all operatively coupled to one or more data buses 1109. Data buses 1109 allow for communication among the various devices. Data buses 1109 can include wired or wireless communication channels.

Processors 1101 can be configured to perform a certain function or operation by executing code, stored on instruction memory 1104, embodying the function or operation. For example, processors 1101 can be configured to perform one or more of any function, method, or operation disclosed herein.

Processors 1101 can include one or more distinct processors, each having one or more cores. Each of the distinct processors can have the same or different structure. Processors 1101 can include one or more central processing units (CPUs), one or more graphics processing units (GPUs), application specific integrated circuits (ASICs), digital signal processors (DSPs), and the like.

Processors 1101 can be configured to perform a certain function or operation by executing code, stored on instruction memory 1104, embodying the function or operation. For example, processors 1101 can be configured to perform one or more of any function, method, or operation disclosed herein.

Instruction memory 1104 can store instructions that can be accessed (e.g., read) and executed by processors 1101. For example, instruction memory 1104 can be a non-transitory, computer-readable storage medium such as a read-only memory, an electrically erasable programmable read-only memory (EEPROM), flash memory, a removable disk, CD-ROM, any non-volatile memory, or any other suitable memory. Processors 1101 can store data to, and read data from, working memory 1102.

For example, processors 1101 can store a working set of instructions to working memory 1102, such as instructions loaded from instruction memory 1104. Processors 1101 can also use working memory 1102 to store dynamic data created during the operation of sales advisory engine 1205. Working memory 1102 can be a random access memory (RAM) such as a static random access memory (SRAM) or dynamic random access memory (DRAM), or any other suitable memory.

Input-output devices 1103 can include any suitable device that allows for data input or output. For example, input-output devices 1103 can include one or more of a keyboard, a touchpad, a mouse, a stylus, a touchscreen, a physical button, a speaker, a microphone, or any other suitable input or output device.

Communication port(s) 1105 can include, for example, a serial port such as a universal asynchronous receiver/transmitter (UART) connection, a Universal Serial Bus (USB) connection, or any other suitable communication port or connection. In some examples, communication port(s) 1105 allows for the programming of executable instructions in instruction memory 1104. In some examples, communication port(s) 1105 allow for the transfer (e.g., uploading or downloading) of data.

Display 1107 can display user interface 1108. User interfaces 1108 can enable user interaction with control device 1100. For example, user interface 1108 can be a user interface for an application (“App”) that allows a user to configure sales advisory engine 1205. In some examples, a user can interact with user interface 1108 by engaging input-output devices 1103. In some examples, display 1107 can be a touchscreen, where user interface 1108 is displayed on the touchscreen. In some examples, display 1107 is a UI Communication Effector that can communicate using modalities such as audio, visual, temperature, smell, or haptic, or any other modality the user may perceive.

Transceiver 1106 allows for communication with a network, such as communication network 1203 of FIG. 12. For example, if communication network 1203 is a cellular network, transceiver 1106 is configured to allow communications with the cellular network. Processor(s) 1101 is operable to receive data from, or send data to, a network, such as communication network 1203, via transceiver 1106.

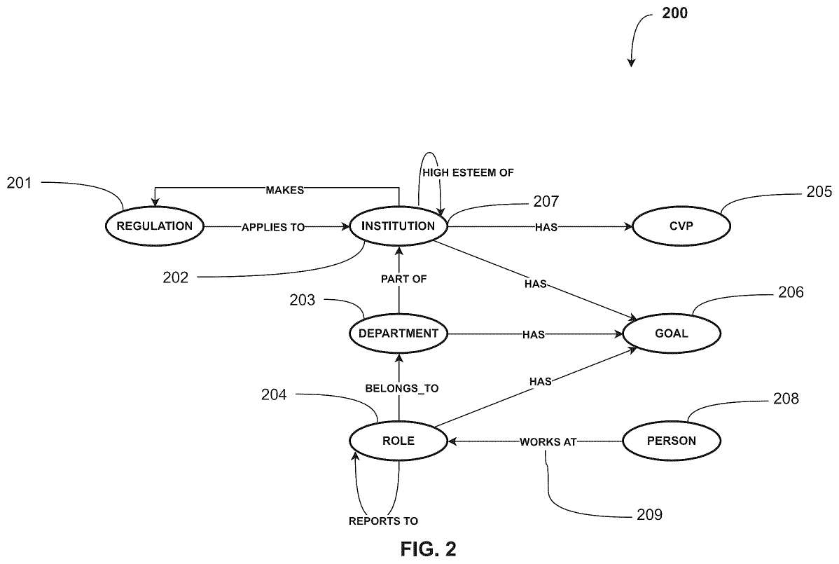

As an illustration of the complexity of information that should be kept in mind during a typical sale, FIG. 2 shows a diagram 200 representing one common set of considerations when attempting sales (or considering further product development). In FIG. 2, the nodes in the graph (i.e., nodes 201, 202, 203, 204, 205, 206, 207, and 208) represent types (e.g., GOAL 206 is any possible goal that PERSON 208 can have). It is important to understand that system 200 represents types, and that type can have multiple concrete instances (e.g., PERSON 208 is type, and Joe Doe and Jane Doe are multiple instances of that type PERSON).

The arrow shows relationships between types (e.g., arrow 209 represents that PERSON 208 “WORKS AT” ROLE 204). This system 200 shows just one example of the complexity of the relationships that should be considered by sales and development professionals at all times and in communications with stakeholders. The human brain's cognitive limitations, such as “seven plus or minus two” information that we can keep in the short-term memory, make domains of this complexity difficult to comprehend, and even when comprehended fully, require a lot of training and persistence, and mental effort on the part of sales professionals to be able to keep in mind. This example of FIG. 2 is one example of the relationships that should be kept in mind to, for example, make a sale. Persons of ordinary skill in art who have the benefit of these disclosures may recognize other advantages to the various embodiments as well.

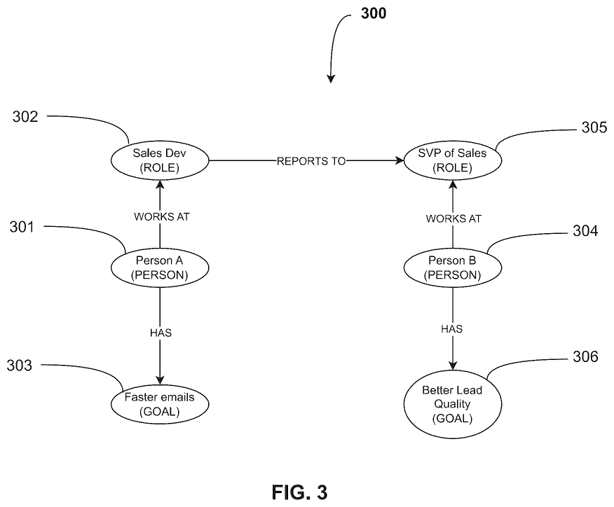

FIG. 3 shows an example of an instance diagram 300 conforming to the data model shown on diagram 200. In diagram 300, there are two concrete instances of type PERSON (208), Person A 301 and Person B 305. Person A 301 works in the type ROLE 204, whose concrete instance is “Sales Dev” 302, and Person B 304 works in type ROLE 204, whose concrete instance is “SVP of Sales” 305. It also illustrates different and not necessarily compatible goal(s) (both of which are instances of type GOAL 206). Person A 301 has a goal of “Faster emails” 303, while Person B 304 has a goal of “Better Lead Quality” 306.

Diagrams 200 and 300 are examples of describing the structure of the goal(s) of the group of market participants with the graph, in accordance with some embodiments. Persons of ordinary skill in the art who have the benefit of these disclosures may recognize other advantages that modification of 200 and 300 bring to the various embodiments as well.

Due to the limitations of the human brain, it is doubtful that a person can quickly create a mental domain picture of all factors affecting any single customer to that level of detail shown in 200 or even 300 based on reading just a set of notes about the history of communication with the customer. It is practically impossible to have a meeting of the form “Let's perform this analysis on 200 people working for the customer we hope to acquire and find CVP(s) for our product to appeal to their goal(s) while taking structure of the goal(s) and power relationships into the account. We also want to identify by the end of this meeting which of those 200 people to approach first, with the best possible value proposition customized for them.”

Diagrams 200 (in FIGS. 2) and 300 (in FIG. 3) can represent one possible form of a data model describing a sales situation. Other variations are possible and obvious to a person ordinarily skilled in the art. In some embodiments of the described system, diagram 300 (in FIG. 3) also encodes a part of a power structure of the market participant (as 302 is reporting to 305, we can assume that there is some amount of power that 305 has over 302). The person ordinarily skilled in the art would be able to expand systems 200 and 300 to describe the different structures of the goal(s) of the group of market participants or to describe different power relationships between market participants, power relationships between persons associated with market participants, or any combination of aforementioned factors.

It is important to note that the goals of the different market participants, people working for the same market participant, or any combination of aforementioned, don't need to be aligned. Quite the contrary, in some embodiments of the system described, the 300 has an example of potentially conflicting goals 303 and 306, as well as an example of why the power relationship between people matters. In 300, the ability to construct the email faster 303 may be important to Person A 301 playing the role of Sales Dev 302, but the ability to write emails faster doesn't necessarily correspond to better lead quality and, in some situations, may even result in lower lead quality (e.g. because it would allow to 301 to send a lot of the emails to prospects that are not a good match, having some of them responding without understanding that they are not the good match). Therefore, in the example given in 300, goal 306 is the goal of Person B 304, who also holds the title SVP of Sales 305 and to whom the role of Sales Dev 302 reports. The power relationship between 301, 302, 305, and 304 means that in the case of disagreement, it is likely that goal 306 is likely to be prioritized over goal 303. Consequently, if you are trying to make the sale to the organization described in 300, you would be in a stronger position if you had CVP(s) that address 306, even if some (or even all) of those CVP(s) are conflicting with 303. As an example, a CVP “We would be able to increase lead quality for 10% in respect to the likelihood of closing while increasing time to write email for Person A 301 for only 5%” could be considered a CVP that addresses conflicting goals while taking power structure into account.

Artificial Intelligence (AI) systems, such as the ones based on Large Language Models (LLMs), can be incorrectly perceived as a solution for finding those relationships. That assumption is misguided—at the time of this filing, it is not clear that there is any LLM system able to comprehend domains of complexity such as diagram 200, and there are plenty of examples of well-known LLM systems such as OpenAI's GPT-4 or Antropic's Claude 3 that can't do it on the complicated domain. Quite the contrary, not only do LLMs have a problem in this domain, but they also have a significant problem getting long-chain inference right (long-chain inference is when to come to the correct conclusion, they have to correctly think about, e.g., ten different decision steps/consideration points—LLM typically make a mistake along that chain, reaching a wrong conclusion). Indeed, no conventional system analyzes a set of notes about communication with customers and propose an automated way to approach a particular person and/or address the goals of a particular customer or a person while taking into account an organizational complexity such as diagram 200 applied to a Fortune 100 company.

The previously discussed limitations in matching CVP(s) with goal(s) are based on physics, science, biology, and technology. In addition to them, real-world organizations using those processes manually also have a problem in that the people making decisions in the later stages of the sales funnel often don't know what people in the earlier phases learned about the customer—e.g., sales developers that initiated first contact with the person may have a little incentive to enter all they know about the customer in the system, because they may not even be aware that “but at customer site, Joe has high esteem of Mike's opinion” is a piece of information that is highly relevant to your company in the later stages of the sales funnel. Therefore, a lot of the information that decision-makers could use is not typically available at the point in time when a decision is made.

Not only is the information that sales developers have not always fully captured in the form accessible to the rest of the organization, but in practice, sales development may have to be educated about a lot of info that the organization has about the structure of the market in which they operate. While that information is often confidential, it is also information that is presented to employees because it enables them to do their job, but sales organization may have a legitimate business reason to withhold that information (or even a preference of not disclosing it, but for the necessity of that information enabling sales developers to do their job). A typical sales organization loses a significant part of its knowledge when a sales developer moves out of the organization, and it may even be exposed to a higher risk of the leak of confidential information.

One embodiment of the disclosed technology can include an AI-based system in which the method of constructing a graph to describe the problem domain is combined with the use of NLP and LLM-based agreement resolution to decide whether the particular CVPs are advantageous to your position in the sales/negotiation cycle.

Diagram 200 (e.g., graph structure 200) is capable of capturing both organizational structures as well as individual and organizational incentives that the customer has. The incentives are shown as GOAL(S) (e.g., type GOAL 206 in FIG. 2, or goal(s) such as Goal 1 104 in FIG. 1 or “Better Lead Quality” 306 in FIG. 3). There is also an ability to describe a set of CVPs 205 that the company is capable of proposing in order to help to the customers reach their incentives.

Organizational structure is crucial for selecting the appropriate CVP for the customer, and so is the regulatory landscape. To make the right CVP, you should propose something that (1) the customer would find interesting, (2) doesn't conflict with other people in his organization that have the power to block it (e.g., the bosses of the employee to whom initial CVP would be shown), (3) doesn't conflict with the regulations such is 201). Furthermore, some of these constituents are more important than others (e.g., winning the approval of the CEO is more important than winning the approval of a random frontline employee). Still, also some nodes representing people that are not necessarily the most powerful in the organization may be crucial for your sales success (e.g., if you are selling a product that would need to be codeveloped with the client to reach its full potential, the acceptance of the senior Research and Development employees may be crucial).

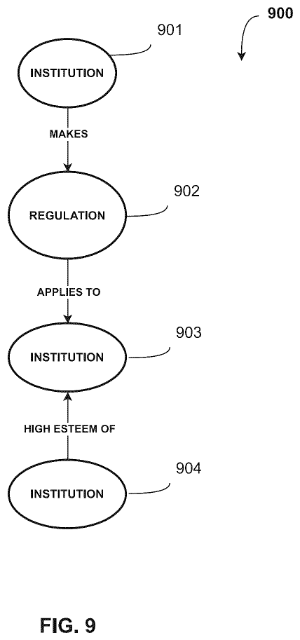

The structure for matching your CVP is described in the form of a configurable system. For example, that configurable system could represent the graph of nodes that you must be able to have a reasonable CVP for (as shown in FIG. 9 for system 900), or the established graph querying language query (such as Cypher) can be used to select a subset of the graph that is matched.

Indeed, FIG. 9 illustrates a query 900 in which INSTITUTION 901 makes REGULATION 902 that applies to other INSTITUTION 903, which is also in the high esteem of the other INSTITUTION 904. This is an example of the configurable pattern showing a market graph structure, which also captures a sales strategy of the form “we must be accepted by the institution that is capable of enacting regulation applying to the big organizations (such as INSTITUTION 903) that are role models that smaller organizations (such as INSTITUTION 904) would follow.” The inability to win the approval of INSTITUTION 901, sales at INSTITUTION 903, or get in conformance with REGULATION 902 invalidates this sales strategy.

It should also be understood that node REGULATION 902 is type REGULATION 201, not necessarily a concrete and binding regulation in the legal sense-it could be a standard operating procedure or even a mere suggestion of the highly respected institution 901, which is influential in your market.

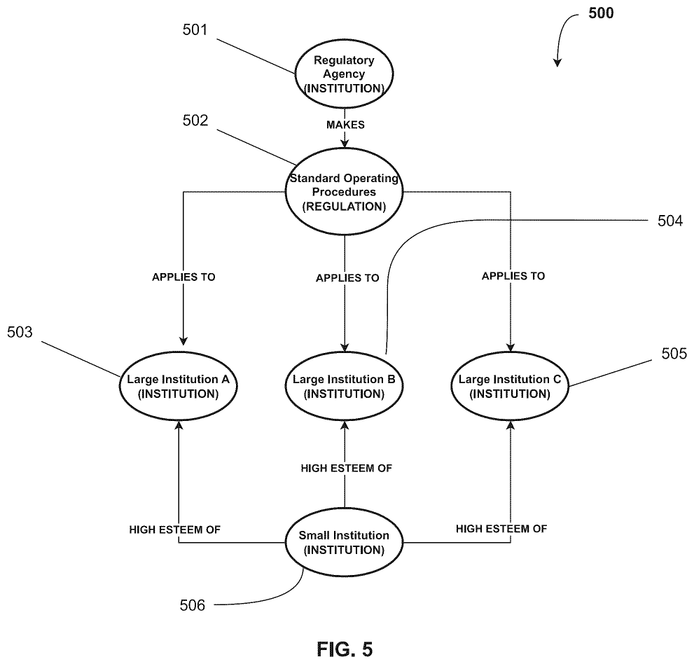

FIG. 5 illustrates a part of the full market graph 500, conformant to the type structure shown in 200, that the query pattern 900 applies to. In the market graph 500, there is regulatory agency 501, which determines (legally non-binding, but influential) standard operating procedures (SOP) 502. That SOP is followed by large institutions in the market, such as Large Institution A 503, Large Institution A 504, and Large Institution C 505. Furthermore, small institutions such as Small Institution 506 look at the large institutions A 503, B 504, and C 505. In such a market, the inability to execute the market strategy, as described in 900, would indicate an inability to succeed in the market 500.

Query 900 is just an example of translating market strategy to the query and applying that market strategy to concrete market situation 500. The person skilled in the art would be able to construct further examples of query 900 in graph structure or different well-known graph description/query approaches such as graph query languages (e.g., Cypher). Such queries and their application to concrete market situations are other embodiments of this invention.

Query 900 could further be used to select a number of nodes for which we must have a reasonable matching CVP in order to succeed in the market. It can also be used to score the importance of each individual node for the success of the market (e.g., 501 and 901 would be highly influential nodes).

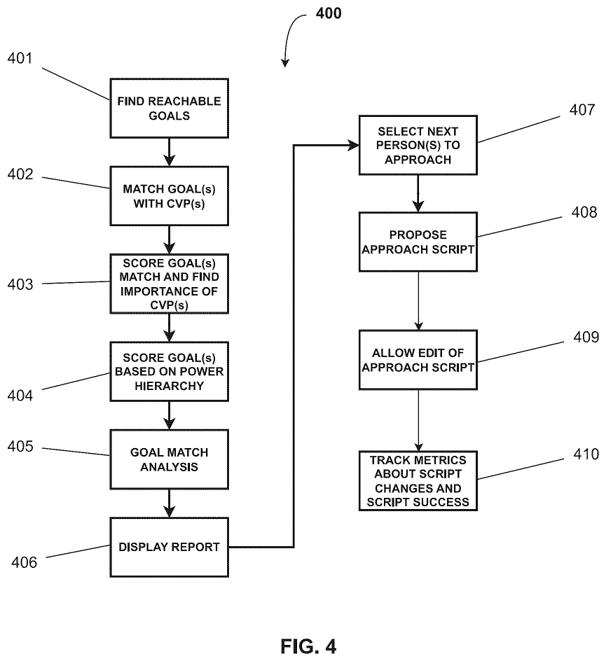

To score matching between the goal(s) and CVP(s), we now turn to FIG. 4, which illustrates a data processing pipeline 400 for matching CVP(s) and goal(s). The algorithm can be performed by a processor executing instructions, such as processor 1101 executing instructions stored in instruction memory 1104. We first find reachable goals that we care about in step 401 (e.g., based on the structure shown in 900). Then, we score a match between goal(s) and CVP(s) in 402. Matching of CVP(s) with the goal(s) of important nodes in the graph could be done using matching techniques for simple matching of unstructured data (e.g., using LLM or NLP techniques to ask, “Does goal and CVP match” or with any combination of LLM, NLP, and graph analytics techniques), and we score that match in 403. Then, we translate the importance of the goal(s) based on the power hierarchy of stakeholders (e.g., as one example, based on queries similar to 900 describing power hierarchies and/or user's manual scoring of the importance of participants). That step 403 shows us the importance of individual CVP(s). To deal with the potentially conflicting goal(s), we score importance of the goal(s) based on the power hierarchy in step 404. Once we know which goal(s) are satisfied with which CVP(s), we perform an analysis of how well we matched the goal(s) individual people and institutions had in step 405. Report 406 of this process is shown to the user in the format including (but not limited to) information on CVP(s) to propose, goal(s) that are met or not met, and people for whom some, all, or none of their goal(s) are met. Report can be shown on any device suitable for presenting information to the user, such as display 1107.

Based on this sorting, the system would be able (based on the proximity in the graph of goal(s) to the various people and the history of previous interactions) to automatically select the next person that should be approached, together with the reason why they should be approached in step 407. The frontline sales developer could then be guided to the next person who should be approached based on the system's estimate of the chance of success of the approach. Furthermore, LLM-based templating or other AI and NLP methods could be used to write approach scripts that match CVP(s) with customer goal(s) in step 408. Those scripts from step 408 can be in the form of text, video, audio, or any other modality perceived by the human. Furthermore, in the step 409, user would be allowed to edit that approach script, and the edits done manually, as well as metrics about the response from customers to whom script is sent, would be tracked by the system in step 410.

In some embodiments of the system described in step 409, the system could allow the user to edit the approach script. The edits made by the sales developer are further analyzed, using LLM and NLP algorithms, to determine (1) the user inserted new proposals that are not in the list of known goal(s) and CVP(s) but could be considered customer GOAL or CVP to propose; and (2) track the effectiveness of CVP(s) based on customer's interaction and engagement with them in step 410.

FIG. 10 illustrates a method 1000, which combines graph-based techniques with the LLM to overcome problems LLMs have in long-chain inference. Method 1000 can be a further expansion on the data processing pipeline 400 of FIG. 4, and can be performed by a processor executing instructions, such as processor 1101 executing instructions stored in instruction memory 1104. In one embodiment of the disclosed technology, unstructured text matching is performed with LLM and NLP methods, but in some other embodiments of the disclosed technology, the use of LLM-based methods is primarily for making simple decisions in which only one or a few inferences need to be made to reach the correct decision. This is an example of short-chain inference—e.g., “Does this CVP support this goal?” typically requires only a single decision.

Method 1000 creates a typed graph of capturing relationships affecting decision structure in step 1001 (e.g., based on the typed graph similar to 200) and in step 1002 formulates query/queries suitable for capturing long-chain inference needed to execute sales strategy (e.g., a query similar to 900). Results of steps 1001 and 1002 are combined for the graph reachability analytical steps shown in 1003 to select from zero to a plurality of nodes of interest in step 1004. Those node(s) 1004 (some examples of such nodes can be goal(s) and CVP(s)) may contain free-form text information that is matched in step 1005. LLM/NLP-based result in step 1005 is information about the characteristics of unstructured text, but LLM is not used as the only means to guide the logic across multiple steps. On the contrary, step 1006 uses graph reachability to guide inference decisions by applying graph analytics and other AI methods to the results generated in steps 1003, 1004, and 1005.

Based on that analysis, the CVP(s) to advance are selected (selected CVPs) in step 1008, and a combination of templating and generative AI may be used to propose an initial communication format that incorporates matched CVP(s). In some embodiments of the described system, the LLM may be used to propose email for communication. In some embodiments, the generative AI could be used to create video or audio messages for communication. The user would have the ability to manually edit the content of the selected communication, and the metrics on those edits and customer responses would be tracked in 1009. Persons of ordinary skill in art who have the benefit of these disclosures may recognize other advantages to the various embodiments as well.

Steps 1008 and 1009 can use the same approach as steps 408 and 409 retrospectively, or could use some combination of a computer supported step and standard operating procedures to manually track metrics.

Algorithm 400 and method 1000 are not limited to proposing CVP(s) that all must come from a single entity (e.g., from just an organization using system 1000). By combining CVP(s) that could be made by different entities (such as institution(s) 207), it is possible to make a joint proposal(s) for the plurality of the market participants, allowing for the proposals that that plurality can make, but none of the subsets of that plurality can. Persons of ordinary skill in art who benefit from these disclosures may also recognize other advantages to the various embodiments.

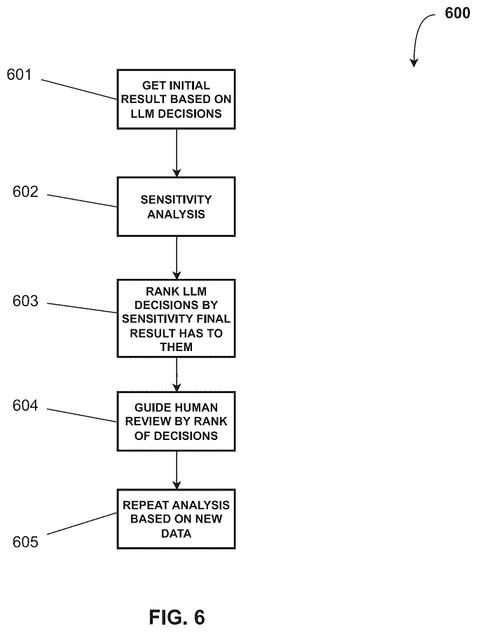

The logic described with respect to method 1000 addresses long-chain inference problems in LLMs, there is still a problem of hallucinations that LLM makes. Even when LLM needs to make a simple, short-chain inference, the match between goal(s) and CVP(s) automatically derived by AI is not always correct. While matching queries in 900 with market graphs such as 500 is deterministic and typically not subject to error, information entered in the graph could have low confidence, and LLM itself can make a mistake in determining a match between the goal(s) and CVP(s). That is why a possible embodiment of the described system may elect to perform a sensitivity analysis 600, as illustrated in FIG. 6, described further below.

FIG. 6 presents a flowchart 600 that can be carried out by a sensitivity analysis processing system to analyze how graph reachability analysis has changed based on individual LLM decisions, and presents those sensitivities for human review and correction. Among other advantages, the flowchart illustrates how to handle hallucinations and check critical chains of decisions in a budget efficient way. In step 601, the initial result based on LLM decisions is obtained. The flowchart can be performed by a processor executing instructions, such as processor 1101 executing instructions stored in instruction memory 1104. At step 602, the sensitivity analysis based on techniques such as Monte Carlo analysis and error propagation is performed, and the LLM decisions from step 601 are ranked in step 603. The scarce time for the human review is then guided in step 604 so that the available time is used to review the information and decisions based on their impact on the overall decision advised by AI. Finally, in step 605, we repeat the analysis based on the corrected data. The one skilled in the art, with the benefit of this disclosure, may recognize modifications of 400, 600 and 1000 that are beneficial to other embodiments.

Based on tracking the effectiveness of individual CVP(s) (including custom-made CVP(s)) tracked in 400, 410, 600, 1000, and 1009, it is possible to (1) determine what are effective CVP(s) and (2) track which of the newly proposed CVP(s) are effective and (3) extract common themes between any set of CVP(s). Those relations can be shown in the report to the different users (e.g., senior management in the company) so that they could use CVP for various decision support purposes (such as measurement of the success of the current strategy based on the success of CVP(s) that are identified as the best proxies for strategic goal(s) the company has). The practitioner, ordinary skilled in the art, would also be able to modify the described system to use it for other management decision support purposes (e.g., by measuring the effectiveness of the individual sales developers, measuring the ability to generate novel proposals accepted by the customers, finding various types of commonalities between those proposals, tracking the evolution of the proposals through time, tracking speed of adaptability to the new information, etc.).

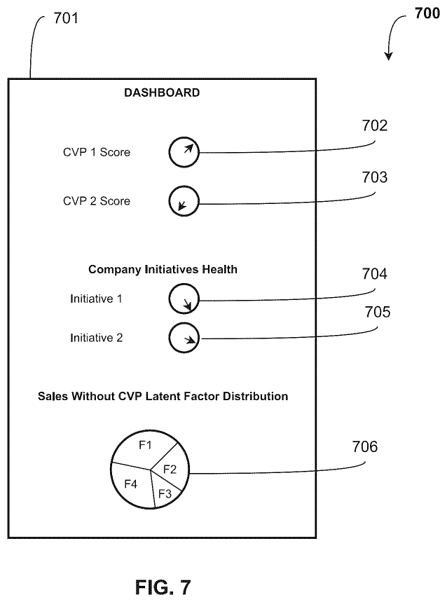

Now, turning to FIG. 7, Dashboard Report 700 presents the effectiveness of CVP(s) for individual sales, as discussed above and herein. In some embodiments, the dashboard UI 701 shows the scoring of the individual CVP(s) (such as 702 and 703) in the context of historically closed sales, based on factors such as match with customer goal(s), size of the closed sale, human report of the importance of the particular CVP on sales, and other factors obvious to those ordinary skilled in art. Those CVP(s) can also be related to the company initiatives they are supporting (704 and 705 show two of such initiatives). Finally, some sales are closed without tying them to a CVP that is in the system or with weak ties/weak matches to the existing CVP(s). Those sales have latent factors, such as the example in 800, that are commonalities between various goal(s) that the sales participants had. In some embodiments of the described system, those latent factors could be constructed from any history of communication with customers. In some other embodiments, the latent factors can also be constructed based on the metrics of edits made in 1009. The 706 shows the distribution of the sales across the latent factors.

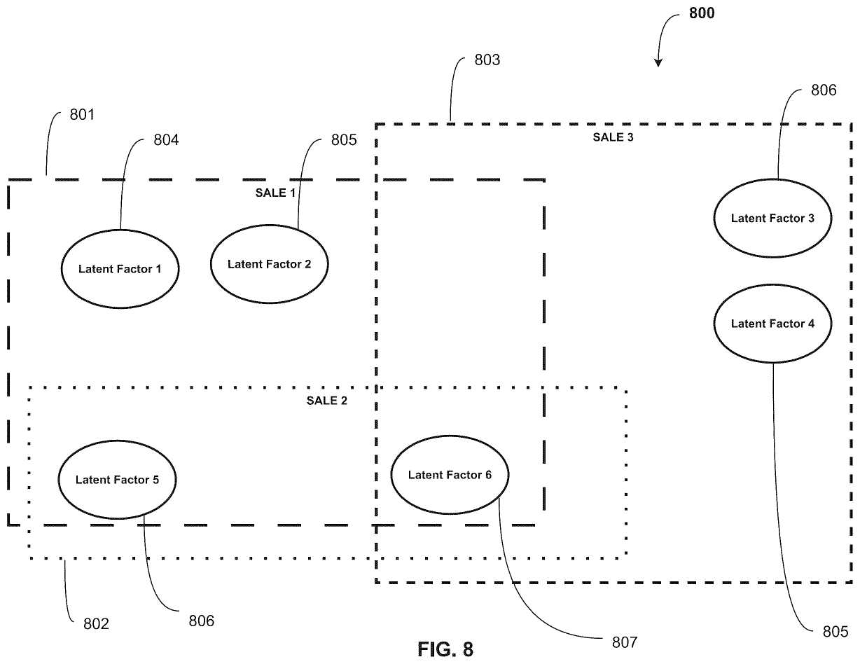

FIG. 8 presents graph 800 of latent factors in sales. There are three sales, with sale 1 (801) having latent factors 1 (804), latent factor 2 (805), latent factor 5 (806), and latent factor 6 (807). Sale 2 (802) has latent factor 5 (806) and latent factor 6 (807), and sale 803 has latent factor 4 (805), latent factor 3 (806), and latent factor 6 (807) in it. All three sales share latent factor 6 (807). Those latent factors influence what is reported in 706, and those latent factors are extracted by using graph reachability techniques to determine goal(s) that participants in the sale had and then using techniques such as Topic Modeling, Latent Dirichlet Allocation, LLMs, and other NLP techniques to find latent factors between the goal(s) that sales participant had. The report on the importance of latent factors 706 allows for prioritization, in which humans should review latent factors to adjust sales or larger corporate strategies. Latent factors can apply to any information related to the sale (e.g. goal(s), CVP(s), or any other information we have about customers or clients).

As the system doesn't need user input when deciding who is the next person to be approached in sales development efforts in 407, the system also doesn't need to present information about the market graph structure it knows to the individual sales developer, protecting the confidentiality of the information. At the same time, as sales developers are primarily working through this system when interacting with the customers, the system can extract and synthesize the joint market graph picture through the plurality of the input of the individual sales developers.

As the analysis presented in 400 is repeated whenever new information is entered into the system (e.g., a new goal is found based on the interaction with the customer), it is possible to have real-time updated knowledge of CVP(s) you can make to any of your customers, based on the plurality of the information you know about the customers. The system would send alerts to appropriate decision-makers and track appropriate reaction time statistics. The person ordinarily skilled in the art could design exact alerts and statistics that are most suitable for alerting purposes based on factors such as stage of sale, monetary value of the sale, general importance of the relationship with the customer, and other well-known factors impacting sales visibility.

The market graph shows organizational and market structures that could determine situations in which some nodes must have matching CVP(s) for a product to be viable for a particular part of the market. Those nodes are nodes with high centrality on paths between important customers (e.g., individuals with high esteem in the industry, or the regulations covering a significant part of the market, or nodes with the ability to define standard operating procedures for the industry). That structure could be further used to advance impact analysis on the total addressable market done in step 1007.

Some nodes or relationships on the graph could be marked as low-confidence relationships when the user of the system is not sure if those relationships are correct or not. As a part of the sensitivity analysis of the goal(s) and CVP(s) match in step 602, the system could determine the sensitivity of its decision-making on the presence or absence of the particular nodes (e.g., by doing Monte-Carlo analysis of the graphs or by tracking which low confidence nodes must be included in the graph that needs to be covered with matching CVP(s)). This sensitivity analysis will then show a report of the influential low-confidence nodes so that those nodes can be further reviewed by humans in step 604.

In some embodiments, the system described addresses commonly known problems of the hallucinations in LLMs and their inability to make a long-chain inference (correctly guess decisions requiring long logical chains of right decisions) by (1) using a graph for directing long-chain inference in the way that is taking into account peculiarities of the sales and negotiations domains as in 400 and 1000; and (2) using human review of the graph structure, ensuring that graph structure is both correct and well-understood; and (3) allows a human to review/correct the LLM decisions such is matching between GOAL and CVP; and (4) spend available manual review resources effectively by guiding manual review based on the results of the sensitivity analysis (e.g. as in step 604).

In some embodiments of the system described, based on the previously described technology for matching subsets of the graph with CVP(s) shown in 400 and 1000, we may combine a plurality of those matches with the configurable expansion criteria (e.g., in the form of “when we make a single sale in this organization, we can count the whole organization as a customer”) to determine total coverage of the market graph that is possible with the current set of CVP(s) in step 1007. The metrics appropriate for measuring graph coverage are then used to determine the proportion of the market graph that we can cover.

In some embodiments of the described system, graph 300 may be just a subset of the total addressable market for the product. Graph 300 requires information to construct, and there is a possibility that an organization constructing it would have to limit the 300 to part of the market that they are familiar with. Therefore, any analysis 1000 performed on that graph would apply only to a part of the market, and extrapolation would be needed to estimate how the analysis will be generalized to the total addressable market. Then, in 1007, statistical inference techniques and sampling techniques (e.g., stratified sampling) are used to estimate the proportion of the total market that could be addressed.

In some embodiments of the described system, the analysis of the plurality of the goal(s) that are unaddressed by the current set of CVP(s) is used to determine the common elements that are unaddressed in the market, guiding management to new CVP(s). Various well-known NLP/LLM/AI techniques (such as topic modeling, latent factor analysis, etc.) could be used to perform this guidance.

In some embodiments of this technology, the area of application is sales development and sales. In some other embodiments of this technology, any form of negotiation (or goal matching) that could be presented with the graph of relations and matching of goal with the proposition is an area of application. Some examples include, but are not limited to, negotiations in any context (business or international), product development guidance, or facilitation of group decisions.

In some embodiments of this technology, a plurality of the business entities is used to propose the joint proposal. Some of the entities may have particular capabilities (CVP(s) they can make), and those CVP(s) can match the goal(s) of multiple different entities. Using 400 and 1000, the GOAL/CVP matching could be used to form a proposal requiring a plurality of the entities (e.g., organization initiating sales, group of customers, and external entity one of the customers has contact with).

Using different modalities of the input information (including but not limited to the text, audio, video, and various sensor data) as an input for the synthesizing information in the market graph or for matching CVP(s) and goal(s) are other embodiments of this invention. Some examples include (but are not limited to) using information based on text-to-speech extraction of the spoken word or video analysis of the body language to highlight goal(s) and reactions to the presentations of those goal(s) to the user.

Some embodiments of the described system can be applied to any situation in which an entity or a group of entities can be described in the graphical form and has goal(s) for which CVP(s) can be applied. Those entities don't have to be physical people (e.g., they could be legal entities, companies, NGOs, governments, government offices, institutions, formal or informal organizations of people, individual people, or any combination of the former). In some embodiment, relationships between those entities can be described with graph(s) that are equivalent to some plausible market graph(s). As one example, there is a possible embodiment in which the described system uses a graph structure that is equivalent to the market graph between some market participants to describe equivalent relationships between Non-Governmental Organizations (NGOs) involved in resolving a problem that doesn't have a profit motive. In the previous example, we say that the graph structure is equivalent between NGOs and one possible market graph of market participants.

Some embodiments of the described system would be collecting metrics in every step of 400, 600, 700, and 1000. The metrics would allow for correlation between CVP(s), communication with customers, and eventual sales closing success, and for a management support system allowing users to understand the relationship between actions taken and success in the marketplace. As the CVP(s) that organizations or individuals can make is related to the current sales strategy, user(s) of the system would be able to understand both how successful their current sales strategy is or the general strategy of the company in its ability to capture a portion of the total addressable market. The person ordinarily skilled in the art having the benefit of these disclosures may recognize other advantages to the various embodiments as well.

In some embodiments of the described system, the computations performed in 400, 600, 800, and 1000 are done either continuously, periodically, when manually triggered by the user, or when new information is made available to the system. When recalculation finds that the information materially impacts the match between CVP(s) and goal(s) or any other form of communication with the market participants we are already engaged with, the user would be alerted.

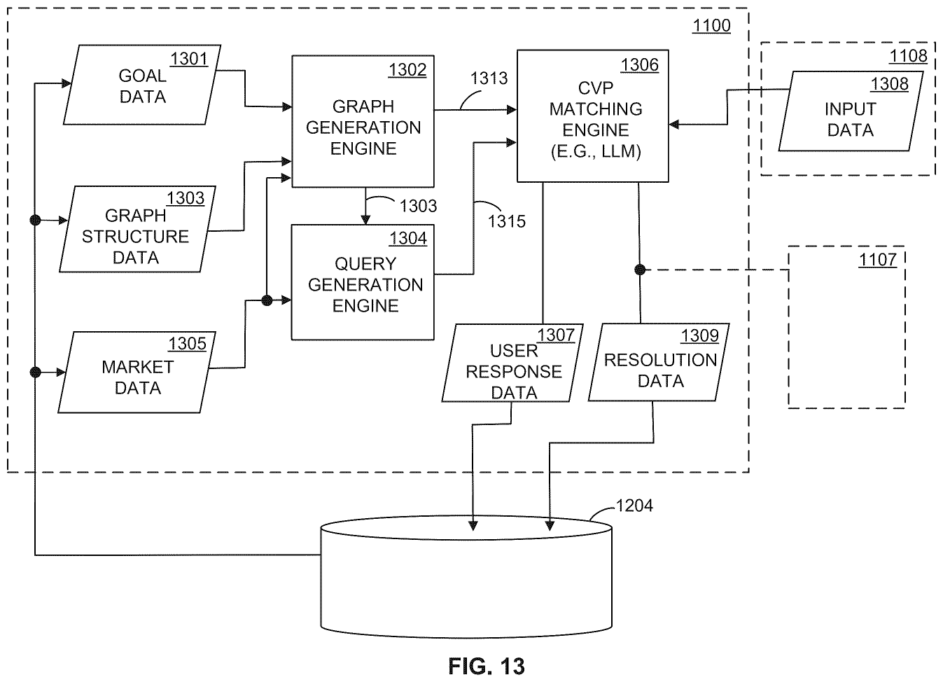

FIG. 13 illustrates example operations of the computing device 1100. For example, as illustrated, the computing device 1100 includes a graph generation engine 1302, a query generation engine 1304, and a CVP matching engine 1306. Each of the graph generation engine 1302, query generation engine 1304, and CVP matching engine 1306 can be implemented by processor 1101 executing instructions stored in instruction memory 1104. In some examples, the computing device 1100 can implement any of the graph generation engine 1302, query generation engine 1304, and CVP matching engine 1306, or any parts thereof, in hardware, such as in one or more FPGAs, ASICS, digital logic, analog logic, or using any other suitable circuitry.

As illustrated, the graph generation engine 1302 can receive goal data 1301, graph structure data 1303, and/or market data 1305 from the data repository 1204. Goal data 1301 can characterize goals (e.g., wanted outcomes, objectives, etc.) of one or more entities (e.g., a person, company, etc.). In addition, graph structure data 1303 can describe a structure of an entity. For instance, graph structure data 1303 can characterize the metamodel of FIG. 2 and/or market graph of FIG. 9. The graph structure data 1303 can also associate each entity with one or more propositions (e.g., CVPs). Market data 1305 can include information on a market to which an entity is a member or participates within. For instance, market data 1305 can include publicly available information with regards to products, cost, profits, sales locations, filed SEC forms, information found on websites, market newsletters, or any other available market information. Market data 1305 can also include private market information that the corresponding entity has access to. Moreover, the market data 1305 can include various input modalities, such as text, video, audio, or any other data.

In some examples, the graph generation engine 1302 inputs the goal data 1301 and graph structure data 1303 to a graphing analytics model (e.g., pathfinding (e.g., Dijkstra's algorithm), similarity analysis, etc.) and, in response, generates graph data 1313 characterizing associations between entities of the graph structure data 1303 and the goals of the goal data 1301. For example, the graph data 1313 may include a graph (e.g., typed graph) that associates (e.g., connects) each of the entities (e.g., and propositions of the entities) with at least one goal identified by the goal data 1301. A single goal can match any number of propositions, and a single proposition can match any number of goals. In some examples, the graph generation engine 1302 inputs the market data 1305 and the goal data 1301 to the LLM and, in response generates graph data 1313 characterizing a graph indicating whether each of the goals of the goal data 1301 are achievable.

Further, the query generation engine 1304 can generate query data 1315 based on the graph data 1303 and, in some examples, the market data 1305. The query data 1315 can characterize queries for long term inference structure (e.g., as described with respect to step 1002 of FIG. 10). For example, the query data 1315 can include queries for each entity of the graph data 1303, where the queries relate to information included in the market data 1305. The CVP matching engine 1306 receives the graph data 1313 from the graph generation engine 1302, and the query data 1315 from the query generation engine 1304. In some examples, the query generation engine 1304 obtains human generated queries from 1204. These human generated queries can be input from on or more users using, for instance, I/O devices 1103 or user interface 1107. The query generation engine 1304 generates the query data 1315 based on the human generated queries. The CVP matching engine 1306 inputs the graph data 1313 and the query data 1315 into an LLM and, in response, can generate resolution data 1309 characterizing a matching between the queries of the query data 1315 and the entities (and propositions and goals) of the graph data 1313. In some examples, the CVP matching engine 1306 applies a trained machine learning model to the graph data 1313 and the query data 1315 to generate the resolution data 1309. The resolution data 1309 can include nodes that identify entities having a goal that matches to a proposition, for instance. The CVP matching engine 1306 can store the resolution data 1309 in the data repository 1204. In some examples, the CVP matching engine 1306 can provide the resolution data 1309 for display, such as to display 1107.

In some examples, a user can provide input data 1308 using, for example, the user interface 1108. The input data 1308 can characterize an inquiry. The CVP matching engine 1306 can receive the input data 1308, and generate a response to the input data 1308 based on inputting the input data 1308 and the resolution data 1309 to the LLM or, in some examples, to the trained machine learning model. For instance, the CVP matching engine 1306 may match the input data 1308 to one or more nodes of the resolution data 1309, and can generate user response data 1307 characterizing the response based on information associated with the one or more nodes.

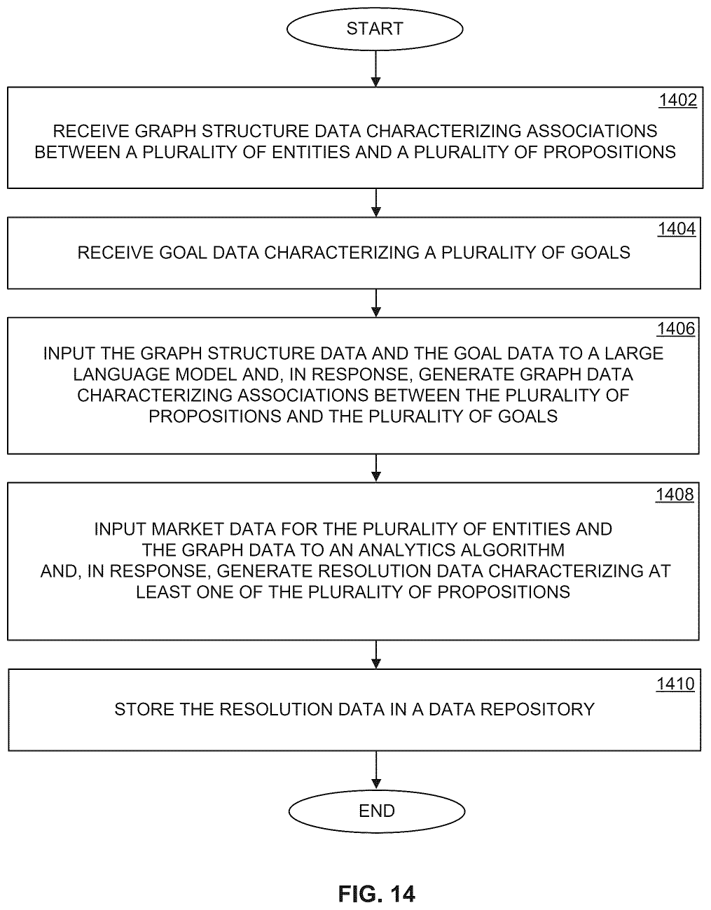

FIG. 14 illustrates a flowchart of a method 1400 to generate resolution data. The method 1400 can be carried out by one or more processors executing instructions, such as by computing device 1100, for example. Beginning at block 1402, the one or more processors receive graph structure data characterizing associations between a plurality of entities and a plurality of propositions. At block 1404, the one or more processors receive goal data characterizing a plurality of goals. Further, at block 1406, the one or more processors input the graph structure data and the goal data to a large language model and, in response, generate graph data characterizing associations between the plurality of propositions and the plurality of goals. At block 1408, the one or more processors input market data for the plurality of entities and the graph data to the large language model and, in response, generate resolution data characterizing at least one of the plurality of propositions. Further, at block 1410, the one or more processors store the resolution data in a data repository (e.g., data repository 1204).

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. An apparatus comprising:
a memory storing instructions; and
a processor communicatively coupled to the memory and configured to execute the instructions to:
receive graph structure data characterizing associations between a plurality of entities and a plurality of propositions;
receive goal data characterizing a plurality of goals;
input the graph structure data and the goal data to an analytics model and, in response, generate graph data characterizing associations between the plurality of propositions and the plurality of goals;
input market data for the plurality of entities and the graph data to a large language model and, in response, generate resolution data characterizing at least one of the plurality of propositions; and
store the resolution data in a data repository.

2. The apparatus of claim 1, wherein the processor is configured to execute the instructions to receive information from a plurality of sources, and aggregate the information as the market data in the data repository, wherein the market data comprises various input modalities.

3. The apparatus of claim 1, wherein the graph structure data associates each of the plurality of propositions to one or more entities, and the resolution data characterizes a corresponding one of the one or more entities.

4. The apparatus of claim 1, wherein the processor is configured to execute the instructions to:
input the graph data to a trained artificial intelligence (AI) model and, based on the inputting the graph data to the trained AI model, generate query data characterizing one or more queries; and
input the query data to the large language model and, in response, generate the resolution data characterizing at least one of the plurality of propositions.

5. The apparatus of claim 4, wherein the processor is configured to execute the instructions to, based on the graph data and the query data, generate matching data charactering associations between the plurality of propositions and the one or more queries.

6. The apparatus of claim 5, wherein the processor is configured to execute the instructions to:
receive input data from a user interface;
determine, based on the matching data, at least one of the plurality of propositions and associated queries;
generate response data based on the at least one of the plurality of propositions and associated queries; and
transmit the response data.

7. The apparatus of claim 1, wherein the processor is configured to execute the instructions to:
generate a ranking score for each of the associations between the plurality of propositions and the plurality of goals based on applying a path finding algorithm to the graph data;
based on the ranking scores, determine a subset of the plurality of propositions; and
provide the subset of the plurality of propositions for display.

8. A method by at least one processor comprising:
receiving graph structure data characterizing associations between a plurality of entities and a plurality of propositions;
receiving goal data characterizing a plurality of goals;
inputting the graph structure data and the goal data to a large language model and, in response, generating graph data characterizing associations between the plurality of propositions and the plurality of goals;
inputting market data for the plurality of entities and the graph data to the large language model and, in response, generating resolution data characterizing at least one of the plurality of propositions; and
storing the resolution data in a data repository.

9. The method of claim 8, comprising receiving information from a plurality of sources, and aggregate the information as the market data in the data repository.

10. The method of claim 8, wherein the graph structure data associates each of the plurality of propositions to one or more entities, and the resolution data characterizes a corresponding one of the one or more entities.

11. The method of claim 8, comprising:
inputting the graph data to a trained artificial intelligence (AI) model and, based on the inputting the graph data to the trained AI model, generating query data characterizing one or more queries; and
inputting the query data to the large language model and, in response, generating the resolution data characterizing at least one of the plurality of propositions.

12. The method of claim 11, comprising, based on the graph data and the query data, generating matching data charactering associations between the plurality of propositions and the one or more queries.

13. The method of claim 12, comprising:
receive input data from a user interface;
determine, based on the matching data, at least one of the plurality of propositions and associated queries;
generate response data based on the at least one of the plurality of propositions and associated queries; and
transmit the response data.

14. The method of claim 8, comprising:
generating a ranking score for each of the associations between the plurality of propositions and the plurality of goals based on applying a path finding algorithm to the graph data;
based on the ranking scores, determining a subset of the plurality of propositions; and
providing the subset of the plurality of propositions for display.

15. An apparatus comprising:
a memory storing instructions; and
a processor communicatively coupled to the memory and configured to execute the instructions to:
receive graph data characterizing associations between a plurality of propositions and a plurality of goals;
receive graph structure data characterizing associations between a plurality of entities and the plurality of propositions;
determine that at least a first of the plurality of propositions is associated with at least a first of the plurality of goals, and not associated with at least a second of the plurality of goals;
input the first of the plurality of propositions and the graph structure data to a large language model and, in response, generate resolution data characterizing whether the first of the plurality of propositions should be proposed; and
store the resolution data in a data repository.

16. The apparatus of claim 15, wherein the first of the plurality of propositions is associated with a first of the plurality of entities that is higher on an organization chart than a second of the plurality of entities that is not associated with the first of the plurality of entities, the resolution data indicating that the first of the plurality of propositions should be proposed.

17. The apparatus of claim 15, wherein the processor is configured to execute the instructions to:
determine that that the first of the plurality of propositions is associated with at least a first of the plurality of entities, and not associated with a second of the plurality of entities; and
determine the first of the plurality of entities has a higher rank than the second of the plurality of entities; and
input the first of the plurality of propositions and the graph structure data to the large language model based on the determination.

18. The apparatus of claim 15, wherein the processor is configured to execute the instructions to:
input the graph data to a trained artificial intelligence (AI) model and, based on the inputting the graph data to the trained AI model, generate query data characterizing one or more queries; and
input the query data to the large language model and, in response, generate the resolution data characterizing at least one of the plurality of propositions.

19. The apparatus of claim 15, wherein the processor is configured to execute the instructions to:
receive market data for the plurality of entities;
inputting the market data and the goal data to the large language model and, in response, generating resolution data characterizing a recommended one of the plurality of propositions; and
providing the resolution data for display.

20. The apparatus of claim 15, wherein the processor is configured to execute the instructions to:
generate a ranking score for each of the associations between the plurality of propositions and the plurality of goals based on applying a path finding algorithm to the graph data;
based on the ranking scores, determine a subset of the plurality of propositions; and
provide the subset of the plurality of propositions for display.
